(19) United States
(12) Patent Application Publication
(10) Pub. No.: US 2026/0168804 A1
(43) Pub. Date: Jun. 18, 2026

(54) PATH PLANNING METHOD AND SYSTEM USING DATA CALCULATION ANALYSIS

(71) Applicant: Pin-Huan CHOU, Taoyuan City (TW)

(72) Inventors: Pin-Huan CHOU, Taoyuan City (TW); Kai-Cheng CHUANG, Nantou County (TW)

(73) Assignee: Pin-Huan CHOU, Taoyuan City (TW)

(21) Appl. No.: 19/532,196

(22) Filed: Feb. 6, 2026

Related U.S. Application Data
(63) Continuation-in-part of application No. 18/664,138, filed on May 14, 2024.
(60) Provisional application No. 63/502,118, filed on May 15, 2023.

(51) Int. Cl. G01C 21/34; G01C 21/36

(52) U.S. Cl. CPC G01C 21/3469; G01C 21/3415; G01C 21/3446; G01C 21/3461; G01C 21/3697

(57) ABSTRACT

A path planning method using data calculation analysis comprising: calculating a driving process data generated by a specific vehicle during the operation of a predetermined driving route by at least one sensor, electronic devices or big data model of the specific vehicle using the vehicle carbon emission data collection algorithm; calculating carbon emissions of each section of the predetermined driving route based on the driving process data; obtaining an actual carbon emissions according to the carbon emissions of each road section by performing a comprehensive addition operation; comparing the actual carbon emissions with a minimum carbon emissions to realize whether an actual carbon reduction amount is above a first predetermined value; when the actual carbon reduction amount is above the first predetermined value, a notification signal is generated for the user to drive on the predetermined driving route.

### CROSS-REFERENCE TO RELATED APPLICATIONS

This application is a continuation-in-part of U.S. patent application Ser. No. 18/664,138, filed on May 14, 2024, the entire contents of which are incorporated herein by reference in its entirety.

### BACKGROUND OF THE INVENTION

### 1. Field of the Invention

The present invention relates to a path planning technology field, and more particularly to a path planning method and system using data calculation analysis.

### 2. Description of the Prior Art

With the increase in environmental awareness, the impact of the greenhouse effect has become increasingly important in all sectors of society. Carbon dioxide emitted during vehicle operation is a major cause of the greenhouse effect. Therefore, how to reduce carbon emissions during vehicle operation through path planning of vehicles has become an urgent issue to be solved in this field.

### SUMMARY OF THE INVENTION

To address the issue of reducing carbon emissions during vehicle operation, the present application provides a path planning method and system using data calculation analysis.

The present invention provides a path planning method and system using data calculation analysis, wherein the path planning method comprises:
calculating driving process data generated by a specific vehicle during operation on a predetermined driving route using at least one sensor of a vehicle, electronic device, or big data model through a vehicle carbon emission data collection algorithm;
calculating carbon emissions of each road section of the predetermined driving route based on the driving process data;
obtaining an actual carbon emission according to the carbon emissions of each road section by using an adder to perform a comprehensive addition operation;
comparing the actual carbon emission with a minimum carbon emission to generate an actual carbon reduction amount and determining whether the actual carbon reduction amount is above a first predetermined value by a processor;
generating a notification signal for a user to drive on the predetermined driving route when the actual carbon reduction amount is above the first predetermined value.

The present invention provides a path planning system using data calculation analysis, wherein the path planning system comprises:
a journey management module for controlling at least one sensor of a vehicle, electronic device, or big data model to calculate driving process data generated by a specific vehicle during operation on a predetermined driving route using a vehicle carbon emission data collection algorithm;
a calculation module for calculating carbon emissions of each road section of the predetermined driving route based on the driving process data;
an operation module for controlling an adder to perform a comprehensive addition operation on the carbon emissions of each road section to obtain an actual carbon emission;
a scoring management module for controlling a processor to compare the actual carbon emission with a minimum carbon emission to generate an actual carbon reduction amount and to determine whether the actual carbon reduction amount is above a first predetermined value; and
a notification management module for generating a notification signal for a user to drive on the predetermined driving route when the actual carbon reduction amount is above the first predetermined value.

The path planning method using data calculation analysis proposed by the present invention comprises:
calculating a driving process data generated by a specific vehicle during operation on a predetermined driving route by at least one sensor of a vehicle, electronic device (such as a smartphone), or big data model using a vehicle carbon emission data collection algorithm; calculating carbon emissions of each road section of the predetermined driving route based on the driving process data; performing a comprehensive addition operation on the carbon emissions of each road section to obtain an actual carbon emission; comparing the actual carbon emission with a minimum carbon emission to generate an actual carbon reduction amount and determining whether the actual carbon reduction amount is above a first predetermined value; when the actual carbon reduction amount is above the first predetermined value, generating a notification signal for the user to drive on the predetermined driving route. The path planning method proposed by the present invention collects driving process data during vehicle operation, and then analyzes this data to calculate the carbon emissions for each road section. Next, it compares whether the actual carbon reduction amount is above the first predetermined value baes on the carbon emissions of each road section, and plans a route with the lowest carbon emissions. This route is then provided to users (such as drivers) to guide their driving, which can help reduce vehicle carbon emissions and thus mitigate environmental pollution.

In order to make the aforementioned and other objectives, features, and advantages of the present invention more comprehensible, the following is a detailed description of the embodiments accompanied by the drawings. In one embodiment, the present invention is implemented as a real-time path planning and carbon emission control system rather than a static data analysis method. The system operates based on a continuous control framework configured to dynamically update carbon emission states and adjust path planning behaviors during vehicle operation.

Specifically, the system comprises a real-time carbon emission control loop. The control loop continuously receives driving process data from one or more data sources, including vehicle-mounted sensors, electronic devices, and external data platforms. The received data is processed to update one or more carbon emission state parameters stored in a memory of the system. These state parameters represent the current carbon emission characteristics associated with road sections, vehicle operation conditions, and route options.

Based on the updated carbon emission state parameters, the system dynamically controls subsequent processing behaviors, including path selection, route re-planning, notification generation, and user guidance. Unlike a one-time calculation process, the control loop repeatedly performs state updating and control decision operations as the vehicle moves or as new data becomes available.

In this framework, notification signals, update signals, and route selection results are treated as control outputs of the system rather than mere informational messages. These outputs are configured to influence subsequent system operations, including triggering route re-generation, modifying path evaluation priorities, and adjusting user guidance behavior in real time. Accordingly, the present invention provides a technical solution in which a computer system actively controls path planning behavior based on continuously updated carbon emission states.

### BRIEF DESCRIPTION OF THE DRAWINGS

FIG. 1 is a flowchart illustrating a path planning method using data calculation analysis according to an embodiment of the present invention;

FIG. 2 is a flowchart illustrating a path planning method using data calculation analysis according to another embodiment of the present invention;

FIG. 3 is a block diagram of a path planning system using data calculation analysis according to an embodiment of the present invention.

### DETAILED DESCRIPTION OF THE PREFERRED EMBODIMENTS

In the following description, various embodiments of the present invention are explained in detail with reference to the drawings. However, it should be understood that the idea of the present invention can be embodied in many different forms and should not be interpreted as limited to the exemplary embodiments set forth herein. In addition, similar elements may be represented by the same reference numerals in the drawings.

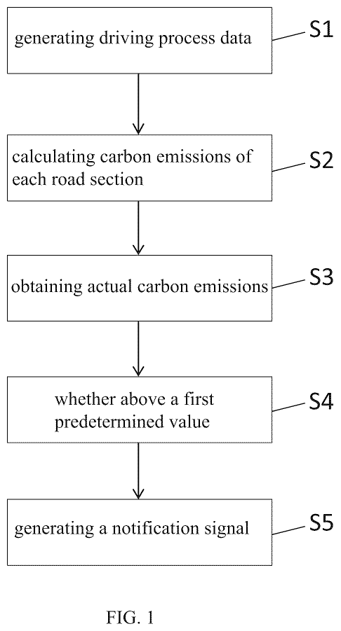

Referring to FIG. 1, FIG. 1 is a flowchart of a path planning method using data calculation analysis according to an embodiment of the present invention. At step S1, driving process data, generated by a specific vehicle during operation on a predetermined driving route, is calculated by at least one sensor of the vehicle, electronic device, or big data model using a vehicle carbon emission data collection algorithm. For example, the at least one sensor of the vehicle may include a speed sensor, a fuel consumption sensor, a wind speed sensor, a rainfall sensor, an OBD (on-board diagnostic)-II interface, an OBD-II reader, etc, which can be used to estimate carbon emissions. When the speed sensor detects that the instantaneous speed or instantaneous acceleration of the vehicle is higher, the carbon emissions increase accordingly. When the fuel consumption sensor detects an increase in fuel consumption, the carbon emissions also increase accordingly. The wind speed sensor can be used in conjunction with the speed sensor. When the wind speed encountered by the vehicle is higher, it means that the instantaneous speed or instantaneous acceleration is higher, and the carbon emissions also increase accordingly. When the rainfall sensor detects an increase in rainfall, the rainwater will carry away more exhaust gases such as carbon compounds emitted by the vehicle, and the carbon emissions will also decrease accordingly. Therefore, the driving process data generated by multiple sensors of the vehicle during the operation on the predetermined driving route includes carbon emission data. The vehicle carbon emission data collection algorithm for calculating the carbon emission data of a specific vehicle can take into account the vehicle energy type (e.g., pure electric vehicle, fuel vehicle, hybrid vehicle, etc.), as well as factors such as vehicle brand, vehicle type (e.g., small car, SUV, truck, articulated vehicle, etc.), vehicle environmental protection standard, vehicle weight, predetermined driving route (e.g., congested road section, high-speed road section, mountain road section, etc.), temperature, vehicle mileage, vehicle tire pressure, vehicle engine, and so on. In addition, the OBD-II interface of the vehicle can be used to obtain data from the vehicle's built-in sensors, and the OBD-II reader can be used to obtain data such as vehicle speed and fuel consumption. For example, the electronic device can use the GPS (global positioning system) and other sensors (e.g., gyroscope, when it detects that the vehicle is tilting upward, it means that it is on a mountain road climbing section of the predetermined driving route) of a smartphone to collect data during the driving process. The built-in or downloaded Google Maps application of the smartphone can be used to collect data during the driving process. In other words, the smartphone can collect data during the driving process through GPS and other sensors, and the smartphone can be used to estimate carbon emissions. In addition, when the big data model is used to estimate the carbon emissions in the driving process data, traffic flow data, weather data, etc. can be used to estimate carbon emissions. In other words, a big data platform can be used to collect and analyze data such as traffic flow data and weather data. For example, the built-in Google Cloud Platform of the electronic device can be used to collect and analyze big data to obtain data such as traffic flow data and weather data. Furthermore, the at least one sensor of the vehicle, electronic device, or big data model utilizes the vehicle carbon emission data collection algorithm through a transportation management system (TMS), a second-generation on-board diagnostic system (OBD-II), or over-the-air (OTA) download technology to calculate the driving process data, mileage information, and fuel consumption data of a specific vehicle on the predetermined driving route during the operation process. This effectively increases the accuracy of the vehicle carbon emission data collection algorithm, allowing for more accurate calculation or prediction of driving process data, including carbon emissions.

In order to support real-time processing and control operations, the system maintains multiple data structures in memory to store intermediate and persistent processing results. These data structures are accessed and updated by different processing modules during system operation.

In one embodiment, the memory of the system stores a road section carbon emission table. The road section carbon emission table records estimated carbon emission values corresponding to individual road sections of candidate routes. Each entry in the table is associated with identifiers of road sections and updated based on driving process data.

The system further maintains a carbon emission state record. The carbon emission state record stores aggregated or derived carbon emission parameters representing the current emission status of a vehicle operating along a selected route. These state parameters are updated dynamically and are used as control inputs for subsequent comparison, scoring, and route planning operations.

In addition, the memory stores a path option data structure. The path option data structure records multiple candidate route options, including general route options, carbon-reducing route options, and fast route options. Each route option is associated with corresponding distance, time, and carbon emission attributes.

To support similarity determination and reward or payment processing, the system further maintains a route comparison buffer and a similarity score record. The route comparison buffer temporarily stores route geometry or segment information of different routes, while the similarity score record stores calculated similarity values for use in subsequent decision-making.

These data structures collectively enable the system to perform state-based processing, control decisions, and route updates in a deterministic and reproducible manner.

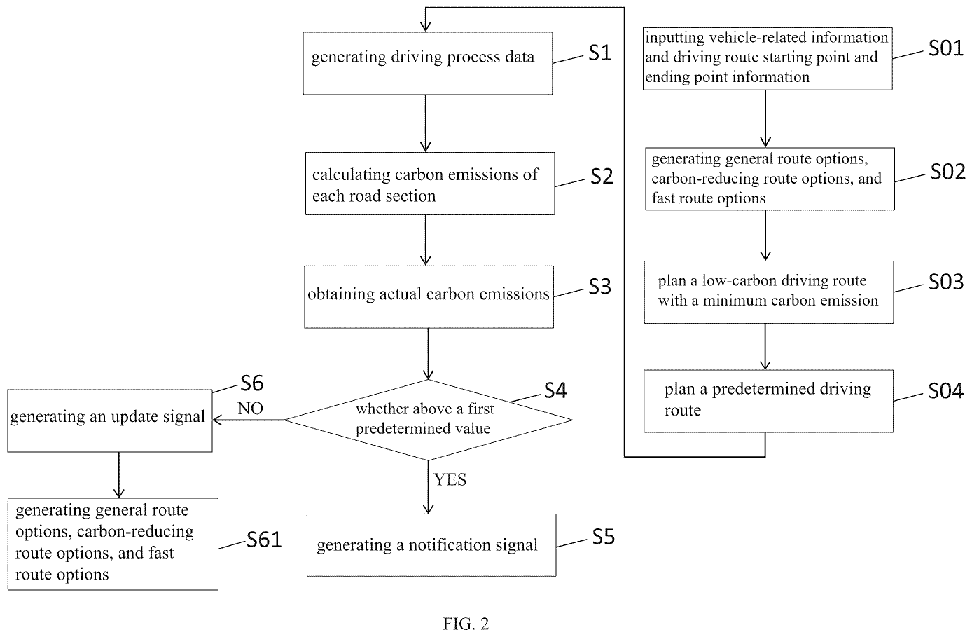

In one embodiment, at step S2, the vehicle carbon emission data collection algorithm calculates the carbon emissions of each road section of the predetermined driving route based on the driving process data. At step S3, an adder with a built-in vehicle carbon emission data collection algorithm performs a comprehensive addition operation according to the carbon emissions of each road section to obtain the actual carbon emissions of the vehicle. Please refer to FIG. 1 and FIG. 2 simultaneously. FIG. 2 is a flowchart of a path planning method using data calculation analysis provided by another embodiment of the present invention. At step S01, a vehicle operation data sorting platform (e.g., bb truck platform) or a third-party map data platform receives vehicle-related information (e.g., vehicle brand factor, vehicle type factor, vehicle environmental protection standard factor, vehicle weight factor, predetermined driving route factor, temperature factor, vehicle mileage factor, vehicle tire pressure factor, vehicle engine factor, etc.), driving route starting point information, and driving route ending point information of a specific vehicle inputted by the electronic device (e.g., smartphone, laptop, or tablet). At step S02, at least one of a high-precision map data model, a traffic prediction model, and a multi-objective path planning algorithm generates general route options, carbon-reducing route options, and fast route options based on the vehicle-related information, driving route starting point information, and driving route ending point information. High-precision map data can provide more accurate road condition information, such as the number of lanes, traffic signs, speed limits, etc., to plan a more precise predetermined driving route. In other words, the API (application programming interface) of a high-precision map data provider is used to obtain high-precision map data. For example, the Google Maps Platform built into the electronic device provides a high-precision map data API. The traffic prediction model built into the electronic device can predict future traffic conditions and plan routes that avoid traffic congestion. In other words, the traffic prediction model API is used to obtain traffic prediction information. For example, the Google Maps Platform provides a traffic prediction model API. The multi-objective path planning algorithm (e.g., A* algorithm (also known as A* search algorithm), Dijkstra algorithm, Bellman-Ford algorithm, Floyd-Warshall algorithm, etc.) built into the electronic device or downloaded through the Internet can consider multiple factors simultaneously, such as travel distance, travel time, carbon emissions, etc., to plan routes that take into account multiple objectives. For example, before driving a vehicle, the user inputs vehicle-related information and the starting and ending points of the predetermined route through the input unit (e.g., a touch screen or keyboard) of the electronic device. At least one of the high-precision map data model, traffic prediction model, and multi-objective path planning algorithm (representing one of the three models and algorithms, or two of them, or a comprehensive application of the three models and algorithms together) provides general route options, carbon-reducing route options, and fast route options through the output unit (e.g., display screen) of the electronic device, effectively increasing user experience and giving drivers multiple driving route options.

In one embodiment, at step S03, the data calculation analysis method is used to plan a low-carbon driving route with the minimum carbon emission according to the carbon-reducing route option. When the driver has multiple driving route options, the carbon-reducing route option uses the data calculation analysis method to plan a low-carbon driving route with the minimum carbon emission. At step S04, the data calculation analysis method is used to plan a predetermined driving route according to the general route option. The general route option uses the data calculation analysis method to plan a predetermined driving route that is commonly used by general users, such as that provided by Google Maps. It is worth noting that when the user selects the fast route option, the data calculation analysis method is used to plan a fast driving route that avoids congested road sections, and the data calculation analysis method does not calculate variable factors such as uphill and downhill sections of the route, or factors that may affect carbon emissions such as vehicle type, mileage, and fuel consumption. The display screen of the electronic device then generates a carbon emission payment message. On the contrary, when the user selects the carbon-reducing route option, the data calculation analysis method is used to plan a low-carbon driving route that avoids congested road sections and considers variables such as weather and vehicle-related information, and the data calculation analysis method calculates variable factors such as uphill and downhill sections of the route, or adds up factors that may affect carbon emissions such as vehicle type, mileage, and fuel consumption. The display screen of the electronic device then generates a reward feedback message, which can offset the carbon emission payment message. This means that the reward feedback message obtained by the user within a certain time range (e.g., a week, a month, a quarter, or a year) can be provided by an environmental protection app platform to offer refueling or charging (applicable to pure electric vehicles) discount information. This effectively generates general route options, carbon-reducing route options, and fast route options through at least one of the high-precision map data model, traffic prediction model, and multi-objective path planning algorithm according to the vehicle-related information, driving route starting point information, and driving route ending point information, allowing users to obtain refueling or charging discount information provided by an environmental protection app platform, increasing carbon reduction and environmental protection, and enhancing user experience.

In one embodiment, at step S4, the processor of the electronic device compares the actual carbon emissions with the minimum carbon emissions to generate an actual carbon reduction amount and determine whether the actual carbon reduction amount is above a first predetermined value. At step S5, when the actual carbon reduction amount is above the first predetermined value, a notification signal is generated for the user to drive according to the predetermined driving route. For example, the first predetermined value can be 15%. When the processor of the electronic device determines that the actual carbon reduction amount generated by comparing the actual carbon emissions and the minimum carbon emissions is 18%, the display screen of the electronic device generates a notification signal for the user to drive according to the predetermined driving route, allowing the user to drive on a low-carbon, convenient, and fast route. On the contrary, at step S6, when the actual carbon reduction amount is not above the first predetermined value (e.g., 5%), an update signal is generated. At step S61, the processor of the electronic device, based on the update signal, generates real-time updated general route options, carbon-reducing route options, and fast route options at the next time and/or the next location by at least one of the high-precision map data model, the traffic prediction model, and the multi-objective path planning algorithm, allowing the driver to select immediately updated general route options, carbon-reducing route options, and fast route options at different times and locations at any time point or location, effectively improving the real-time updating of road condition information. At step S5, when the actual carbon reduction amount is above the first predetermined value, a notification signal is generated for the user to drive according to the predetermined driving route. Furthermore, the vehicle operation data sorting platform or the third-party map data platform determines the similarity between the low-carbon driving route and the predetermined driving route. When the similarity between the low-carbon driving route and the predetermined driving route is higher than a second predetermined value (e.g., 90%), the actual carbon emission reduction amount will generate an immediate reward feedback message according to the price announced by the vehicle operation data sorting platform or the third-party map data platform. When the similarity between the low-carbon driving route and the predetermined driving route is lower than a third predetermined value (e.g., 75%), a carbon emission payment message is generated. The reward feedback message can offset the carbon emission payment message, representing that the reward feedback message and the carbon emission payment message are negatively correlated. The obtained reward feedback message can be provided by an environmental protection app platform in combination with the vehicle operation data sorting platform or the third-party map data platform to offer refueling or charging discount information, effectively increasing environmental protection while reducing carbon pollution.

In one embodiment, the path planning system 300 further includes an update stabilization mechanism 397 configured to prevent excessive or oscillatory route updates. The update stabilization mechanism 397 limits the frequency or number of route re-generation events within a predetermined time window.

For example, the update stabilization mechanism 397 may suppress repeated update signals when carbon emission state parameters fluctuate within a predefined tolerance range. This mechanism improves system stability and reduces unnecessary computation while maintaining effective control performance.

For example, the application uses the vehicle information provided by the vehicle owner as the basis for determining the carbon emissions, combined with the starting point and destination inputted by the user, utilizes third-party map data to calculate the distance and real-time road conditions, and plans the route with the lowest carbon emissions. Finally, the vehicle carbon emission data collection algorithm is used to calculate the actual carbon emissions, determine the actual carbon reduction amount, and calculate the reward feedback provided to the user based on this. The present application involves a method of path planning using data calculation analysis, as well as a way to collect data during the driving process to achieve the lowest carbon emission route planning. The method comprises the following steps: First, data is collected during the driving process, including the vehicle's speed, acceleration, fuel consumption, etc. Then, these data are analyzed to calculate the carbon emissions of each road section. Next, based on the carbon emissions, a data calculation analysis method is used to plan the route with the minimum carbon emissions. Finally, the route is provided to the driver to guide their driving. This method can help reduce the carbon emissions of vehicles, thereby reducing the impact on the environment. In addition, this method can also plan personalized routes according to different needs, such as travel time, travel distance, weather changes, etc. Personalized path planning includes general route options, carbon-reducing route options, and fast route options. The present application can focus on reinforcing the “path planning method” in steps S01˜S04 and the “data collection method during the driving process” in steps S1˜S6, and add example explanations of usage scenarios, such as how different variables affect the path planning method, what different routes are ultimately planned, or how to calculate carbon emissions based on the collected data, confirming whether the low-carbon option is followed to complete the task. In other words, the present application effectively generates carbon-reducing route options through at least one of the high-precision map data model, traffic prediction model, and multi-objective path planning algorithm according to vehicle-related information, driving route starting point information, and driving route ending point information to confirm whether the user follows the low-carbon option to complete the task, obtains refueling (applicable to fuel-consuming vehicles and hybrid vehicles) or charging discount information provided by an environmental protection app platform, increases the earth's carbon reduction and reduces environmental pollution, and enhances user experience.

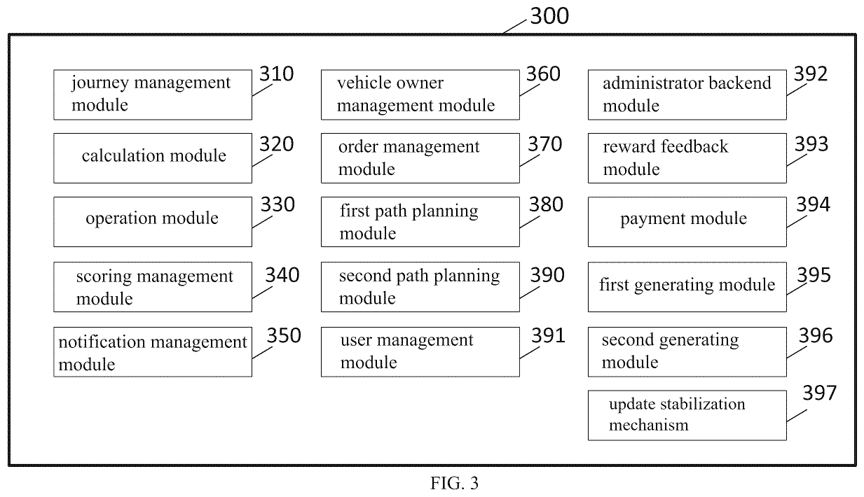

Please refer to FIG. 3, which is a block diagram of a path planning system using data calculation analysis according to an embodiment of the present invention. The present invention provides a path planning system 300 using data calculation analysis, wherein the path planning system 300 comprises:
a journey management module 310 for controlling at least one sensor of a vehicle, electronic device, or big data model to calculate driving process data generated by a specific vehicle during operation on a predetermined driving route using a vehicle carbon emission data collection algorithm;
a calculation module 320 for calculating the carbon emissions of each road section of the predetermined driving route based on the driving process data;
an operation module 330 for controlling an adder to to perform a comprehensive addition operation on the carbon emissions of each road section to obtain an actual carbon emission;
a scoring management module 340 for controlling a processor to compare the actual carbon emission with a minimum carbon emission to generate an actual carbon reduction amount and to determine whether the actual carbon reduction amount is above a first predetermined value; and
a notification management module 350 for generating a notification signal for a user to drive on the predetermined driving route when the actual carbon reduction amount is above the first predetermined value.

In the present invention, the modules illustrated in FIG. 3 are not abstract functional blocks but are implemented as processing units forming a sequential data processing pipeline. Each module is implemented by one or more processors executing corresponding instruction sets stored in memory, and each module performs a defined category of processing operations.

The journey management module 310 is configured to receive driving process data from vehicle sensors, electronic devices, or external data platforms. The journey management module 310 performs data reception, synchronization, filtering, and format normalization operations to generate standardized driving process data suitable for subsequent processing.

The calculation module 320 is configured to execute road section-level processing operations. These operations include segmenting driving process data according to road sections, applying carbon emission estimation functions to individual segments, and writing calculated results into the road section carbon emission table.

The operation module 330 is configured to aggregate road section- level carbon emission values. The operation module 330 accesses the road section carbon emission table and performs accumulation or summation operations to generate actual carbon emission values, which are stored as part of the carbon emission state record.

The scoring management module 340 is configured to perform comparison and decision operations. The scoring management module 340 retrieves actual carbon emission values and corresponding minimum carbon emission values from memory, performs comparison operations, and updates one or more control flags indicating whether predetermined threshold conditions are satisfied.

The notification management module 350 is configured to generate control outputs based on the control flags. These outputs may include notification signals, update signals, or user interface triggers, each of which is configured to influence subsequent system operations or user guidance behavior.

By organizing the modules into a processing pipeline, the system ensures deterministic data flow and enables reproducible execution of path planning and control operations.

In one embodiment, the path planning system 300 comprises:
a vehicle owner management module 360 for controlling a vehicle operation data sorting platform or a third-party map data platform to receive vehicle-related information, driving route starting point information, and driving route ending point information of the specific vehicle inputted by the electronic device;
an order management module 370 for controlling at least one of a high-precision map data model, a traffic prediction model, and a multi-objective path planning algorithm to generate a general route option, a carbon-reducing route option, and a fast route option based on the vehicle-related information, the driving route starting point information, and the driving route ending point information;
a first path planning module 380 for utilizing the data calculation analysis method to plan a low-carbon driving route with the minimum carbon emission based on the carbon-reducing route option; and
a second path planning module 390 for utilizing the data calculation analysis method to plan the predetermined driving route based on the general route option.

In one embodiment, the first path planning module 380 and the second path planning module 390 are configured to generate candidate routes based on different optimization objectives.

The first path planning module 380 generates one or more general route options by constructing a route graph in which nodes represent road intersections and edges represent road sections. Each edge is assigned a weight corresponding to distance or travel time. The module performs a graph-based search operation to identify one or more candidate routes between a start location and a destination.

The second path planning module 390 generates one or more carbon-reducing route options by modifying edge weights of the route graph based on carbon emission state parameters stored in the carbon emission state record. Road sections associated with higher carbon emission values are assigned higher weights, thereby reducing the likelihood that such road sections are included in selected routes.

In one embodiment, the first path planning module 380 and the second path planning module 390 share a common graph representation while applying different weighting schemes and constraints. This configuration enables the system to generate multiple route options optimized for different objectives without duplicating underlying data structures.

In one embodiment, the vehicle owner management module 360 is configured to manage user-related technical parameters used during path planning and control operations. The vehicle owner management module 360 maintains a user profile record stored in the memory.

The user profile record includes one or more preference parameters associated with a vehicle owner, such as carbon emission sensitivity, travel time preference, or notification frequency preference. These parameters are represented as numerical values or weighting coefficients.

During operation, the vehicle owner management module 360 provides the preference parameters to the scoring management module 340 and the path planning modules. The preference parameters are used to adjust weighting factors applied during route evaluation or threshold determination, thereby enabling technical customization of system behavior without modifying core algorithms.

In one embodiment, the order management module 370 is configured to manage emission-related transaction states rather than performing general commercial order processing. The order management module 370 maintains an emission offset record stored in the memory.

The emission offset record records carbon emission offset information corresponding to completed journeys, including accumulated emission values, offset eligibility status, or reward identifiers. The emission offset record is updated based on similarity score records and control flags generated during system operation.

The order management module 370 provides emission offset information to the notification management module 350 to enable generation of reward notifications or offset confirmations. In this configuration, the order management module 370 functions as a technical state management component integrated with the carbon emission control framework.

In one embodiment, the path planning system 300 comprises:
a user management module 391 for controlling at least one sensor of the vehicle, electronic device, or big data model to calculate the driving process data, a mileage information, and a fuel consumption data of the specific vehicle operating on the predetermined driving route using the vehicle carbon emission data collection algorithm via a transportation management system, an on-board automatic diagnosis system, or an over-the-air download technology.

In one embodiment, the path planning system 300 comprises:
an administrator backend module 392 for controlling the vehicle operation data sorting platform or the third-party map data platform to determine a similarity
between the low-carbon driving route and the predetermined driving route;
a reward feedback module 393 for generating a reward feedback message when the similarity between the low-carbon driving route and the predetermined driving route is higher than a second predetermined value;
a payment module 394 for generating a carbon emission payment message when the similarity between the low-carbon driving route and the predetermined driving route is lower than a third predetermined value.

In one embodiment, the path planning system 300 comprises:
a first generating module 395 for generating an update signal when the actual carbon reduction amount is not higher than the first predetermined value; and
a second generating module 396 for generating the general route option, the carbon-reducing route option, and the fast route option at a next moment and/or a next location by at least one of the high-precision map data model, the traffic prediction model, and the multi-objective path planning algorithm, according to the update signal. Please refer to the content of FIGS. 1-2 for the embodiment description of FIG. 3, which will not be repeated here.

In one embodiment, the system is implemented in a distributed hardware environment comprising a vehicle-mounted computing device, an electronic device operated by a user, and one or more remote servers. Different processing modules may be deployed on different hardware components based on latency, computational load, and real-time requirements.

For example, modules responsible for receiving driving process data and performing initial carbon emission estimation may be deployed on a vehicle-mounted computing unit to enable real-time processing. Modules responsible for route planning, multi-objective optimization, and candidate route generation may be deployed on an electronic device or a remote server.

The distributed components communicate with one another via wired or wireless communication interfaces, including cellular networks, short-range wireless communication, or over-the-air update mechanisms. Data exchanged between components may include carbon emission state records, route option data structures, and control outputs.

In one embodiment, certain computation-intensive operations, such as multi-objective path planning or traffic prediction, are offloaded to remote servers, while latency-sensitive operations remain on the vehicle-mounted device. This deployment configuration reduces system response time and improves real-time control performance.

Through such hardware deployment and distributed execution embodiments, the present invention provides a concrete system architecture supporting real-time, state-based path planning and carbon emission control.

Although the present invention has been disclosed in the above embodiments, they are not intended to limit the present invention. Those with ordinary skilled in the art can make some modifications and refinements without departing from the spirit and scope of the present invention. Therefore, the scope of the present invention should be defined by the appended claims.

What is claimed is:

1. A path planning method and system of using data calculation analysis, wherein the path planning method comprises:
calculating a driving process data generated by a specific vehicle during operation on a predetermined driving route by at least one sensor of a vehicle, electronic device, or big data model using a vehicle carbon emission data collection algorithm;
calculating carbon emissions of each road section of the predetermined driving route based on the driving process data;
obtaining an actual carbon emission according to the carbon emissions of each road section by using an adder to perform a comprehensive addition operation;
comparing the actual carbon emission with a minimum carbon emission to generate an actual carbon reduction amount and determining whether the actual carbon reduction amount is above a first predetermined value by a processor; and
generating a notification signal for a user to drive on the predetermined driving route when the actual carbon reduction amount is above the first predetermined value.

2. The path planning method of claim 1, wherein before calculating the driving process data generated by the specific vehicle during operation on the predetermined driving route by the at least one sensor of the vehicle, electronic device, or big data model using the vehicle carbon emission data collection algorithm, the path planning method comprises:
receiving vehicle-related information, driving route starting point information, and driving route ending point information of the specific vehicle inputted by the electronic device via a vehicle operation data sorting platform or a third-party map data platform;
generating a general route option, a carbon-reducing route option, and a fast route option based on the vehicle-related information, the driving route starting point information, and the driving route ending point information by at least one of a high-precision map data model, a traffic prediction model, and a multi-objective path planning algorithm;
planning a low-carbon driving route with the minimum carbon emission according to the carbon-reducing route option using the data calculation analysis method; and
planning the predetermined driving route according to the general route option using the data calculation analysis method.

3. The path planning method of claim 1, wherein in calculating the driving process
data generated by the specific vehicle during operation on the predetermined driving route by the at least one sensor of the vehicle, electronic device, or big data model using the vehicle carbon emission data collection algorithm, the path planning method comprises:
calculating the driving process data, a mileage information, and a fuel consumption data of the specific vehicle operating on the predetermined driving route during operation by the at least one sensor of the vehicle, electronic device, or big data model using the vehicle carbon emission data collection algorithm through a transportation management system, an on-board automatic diagnosis system, or an over-the-air download technology.

4. The path planning method of claim 2, wherein, when the actual carbon reduction amount is above the first predetermined value, in generating the notification signal for the user to drive on the predetermined driving route, the path planning method comprises:
determining a similarity between the low-carbon driving route and the predetermined driving route by the vehicle operation data sorting platform or the third-party map data platform;
generating a reward feedback message when the similarity between the low-carbon driving route and the predetermined driving route is higher than a second predetermined value;
generating a carbon emission payment message when the similarity between the low-carbon driving route and the predetermined driving route is lower than a third predetermined value.

5. The path planning method of claim 2, after comparing the actual carbon emission with the minimum carbon emission to determine whether the actual carbon reduction amount is above the first predetermined value by the processor, the path planning method comprises:
generating an update signal when the actual carbon reduction amount is not higher than the first predetermined value;
generating the general route option, the carbon-reducing route option, and the fast route option at a next moment and/or a next location by at least one of the high-precision map data model, the traffic prediction model, and the multi-objective path planning algorithm, according to the update signal.

6. A path planning system of using data calculation analysis, wherein the path planning system comprises:
a journey management module for controlling at least one sensor of a vehicle, electronic device, or big data model to calculate driving process data generated by a specific vehicle during operation on a predetermined driving route using a vehicle carbon emission data collection algorithm;
a calculation module for calculating carbon emissions of each road section of the predetermined driving route based on the driving process data;
an operation module for controlling an adder to perform a comprehensive addition operation on the carbon emissions of each road section to obtain an actual carbon emission;
a scoring management module for controlling a processor to compare the actual carbon emission with a minimum carbon emission to generate an actual carbon reduction amount and to determine whether the actual carbon reduction amount is above a first predetermined value; and
a notification management module for generating a notification signal for a user to drive on the predetermined driving route when the actual carbon reduction amount is above the first predetermined value.

7. The path planning system of claim 6, wherein the path planning system comprises:
a vehicle owner management module for controlling a vehicle operation data sorting platform or a third-party map data platform to receive vehicle-related information, driving route starting point information, and driving route ending point information of the specific vehicle inputted by the electronic device;
an order management module for controlling at least one of a high-precision map data model, a traffic prediction model, and a multi-objective path planning algorithm to generate a general route option, a carbon-reducing route option, and a fast route option based on the vehicle-related information, the driving route starting point information, and the driving route ending point information;
a first path planning module for utilizing the data calculation analysis method to plan a low-carbon driving route with the minimum carbon emission based on the carbon-reducing route option;
a second path planning module for utilizing the data calculation analysis method to plan the predetermined driving route based on the general route option.

8. The path planning system of claim 6, wherein the path planning system comprises:
a user management module for controlling at least one sensor of the vehicle, electronic device, or big data model to calculate the driving process data, a mileage information, and a fuel consumption data of the specific vehicle operating on the predetermined driving route using the vehicle carbon emission data collection algorithm via a transportation management system, an on-board automatic diagnosis system, or an over-the-air download technology.

9. The path planning system of claim 7, wherein the path planning system comprises:
an administrator backend module for controlling the vehicle operation data sorting platform or the third-party map data platform to determine a similarity between the low-carbon driving route and the predetermined driving route;
a reward feedback module for generating a reward feedback message when the similarity between the low-carbon driving route and the predetermined driving route is higher than a second predetermined value;
a payment module for generating a carbon emission payment message when the similarity between the low-carbon driving route and the predetermined driving route is lower than a third predetermined value.

10. The path planning system of claim 7, wherein the path planning system comprises:
a first generating module for generating an update signal when the actual carbon reduction amount is not higher than the first predetermined value;
a second generating module for generating the general route option, the carbon-reducing route option, and the fast route option at a next moment and/or a next location by at least one of the high-precision map data model, the traffic prediction model, and the multi-objective path planning algorithm, according to the update signal.

11. A system for real-time path planning based on carbon emission, comprising:
a memory configured to store executable instructions and data structures; and
one or more processors coupled to the memory and configured to execute the instructions to:
receive driving process data associated with a vehicle;
generate carbon emission data corresponding to road sections based on the driving process data;
store the carbon emission data in at least one carbon emission state record in the memory;
generate a plurality of candidate routes including at least a general route and a carbon-reducing route;
compare actual carbon emission data associated with a selected route with a minimum carbon emission value derived from the plurality of candidate routes; and
generate a control output configured to influence subsequent route selection or route update operations based on the comparison,
wherein the one or more processors repeatedly update the carbon emission state record and generate the control output during vehicle operation.

12. The system of claim 11, wherein the control output comprises at least one of a notification signal and a route update signal configured to trigger generation of a new candidate route.

13. The system of claim 11, wherein the carbon emission data is generated at a road section level and stored in a road section carbon emission table in the memory.

14. The system of claim 11, wherein generating the plurality of candidate routes comprises applying different weighting schemes to a common route graph.

15. The system of claim 11, wherein the one or more processors are configured to generate the carbon-reducing route by assigning higher weights to road sections associated with higher carbon emission values.

16. The system of claim 11, further comprising an update stabilization mechanism configured to limit a frequency of route update operations within a predetermined time window.
